(19) United States
(12) Patent Application Publication
(10) Pub. No.: US 2004/0130596 A1
(43) Pub. Date: Jul. 8, 2004

(54) Apparatus and method for pattern formation on conductive substrates

(75) Inventors: Chen-Hao Liu, Taoyuan (TW); Chun-Jung Chen, Yunlin (TW)

Correspondence Address: QUINTERO LAW OFFICE, 1617 BROADWAY, 3RD FLOOR, SANTA MONICA, CA, 90404, US

(73) Assignee: Industrial Technology Research Institute

(21) Appl. No.: 10/610,065

(22) Filed: Jun. 30, 2003

(30) Foreign Application Priority Data
Jan. 3, 2003 (TW) 92100123

(51) Int. Cl. B41J 2/06

(52) U.S. Cl. 347/55

(57) ABSTRACT

An apparatus for pattern display is formed by projection. The apparatus includes an aperture electrode device having a plurality of ring electrodes with apertures, a voltage control device connected to the ring electrodes by copper circuits, a movable conductive substrate electrode of a glass substrate evaporated with conductive material thereon and a feeding device for charging the organic luminary powder by friction. The feeding device includes a feeding roller and a magnetic roller with a magnetic rod therein. The magnetic roller rolls in the same direction to feed the organic luminary powder and the ferromagnetic carrier beads. The friction between the ferromagnetic beads and the organic luminary powder charges the powder.

### BACKGROUND OF THE INVENTION

1. Field of the Invention

The present invention relates to an apparatus for pattern formation, and in particular to an apparatus for pattern formation on conductive substrates.

2. Description of the Related Art

Organic Light-Emitting Diode (OLED) is currently the most powerful display technology. OLED has a wider viewing angle, more colors and higher contrast than liquid crystal displays. OLED display also has low cost and sizes as small as 20 mm or less.

The conventional method for forming the OLED organic luminary layer is to coat a luminary powder layer on a substrate using spin-coating method adapted to polymer or evaporation method using smaller organic molecules. Another method for forming organic luminary layer is to dissolve the organic luminary material in the solvent and then project the solution onto the substrate to form a predetermined pattern of organic luminary powder by ink projection as described in U.S. Pat. No. 6,087,196.

FIG. 1 shows a conventional OLED coating method, evaporation. The organic luminary powder is contained in the crucible 13 and heated in a heater 14 on the bottom of the vacuum oven 11. When the organic luminary powder is evaporated, the vapor is distributed throughout the vacuum oven and some of the vapor attaches to the substrate 12 above the crucible 13. However, only below 20% of the organic luminary particle attaches to the substrate and the rest to the walls of the vacuum oven, creating a distinct waste of material.

Hence, the invention provides a new coating method which utilizes an electrical projecting technology known as a TonerJet method, based on a toner particle projection method used in printers, known as TonerJet.

The TonerJet method (U.S. Pat. No. 5,614,932) is shown in FIG. 2. Charged toner particle 216 is attracted by electrostatic field and then projected onto a substrate (e.g. paper) 220 through control apertures 206 on an aperture electrode device 202. The voltage of the control apertures 206 determines the throughout of the toner particle 216, and the size of aperture 206 and control signal determine its distribution on the substrate 220. The details of the method are described as follows.

A feeding roller 212 and a magnetic roller 214 roll are used to feed toner particle 216 and mix the toner particle 216 with carrier beads, charging the carbon powder 216 by friction. Limiter 218 controls the amount of toner particle 216 reaching the control apertures 206. When the charged toner particle 216 is carried to the apertures 206 by magnetic roller 214, the toner particle 216 is attracted by the electrical field formed between the magnetic roller 214 and electrode roller 222 and projected on the substrate (paper) 220. The voltage of electrode roller 222 is controlled by central processor unit 234, voltage control device 208 and voltage supply device 224. The voltage level and polarity of ring electrodes 204 control the throughout of the toner particle 216 through the apertures 206.

### SUMMARY OF THE INVENTION

Accordingly, an object of the invention is to provide an apparatus and a method for pattern formation on a conductive substrate which can be applied to OLED manufacturing.

The apparatus in the present invention comprises an aperture electrode device provided with a plurality of ring electrodes and a plurality of apertures corresponding thereto, a plurality of ferromagnetic carrier beads, a feeding device for feeding organic is luminary powder including a feeding roller and a magnetic roller which mix the organic luminary powder with the ferromagnetic carrier beads and charge the organic luminary powder by friction, a movable conductive substrate provided with a plate and a layer of conductive material coated on the plate, a voltage supply device providing voltage for the movable conductive substrate and the magnetic roller, at least one electrical conductor roller connected to the voltage supply device contacting the movable conductive substrate to provide voltage for the movable conductive substrate, and a voltage control device controlling the voltage in the ring electrodes thereby forming an electrical field to attract or repel the organic luminary powder. The aperture electrode device further comprises a flexible circuit board mounted between the magnetic roller and the conductive substrate, made of Polyimide.

The apparatus further comprises a copper circuit with which the voltage control device connects to the ring electrodes and a signal processor to control the voltage level and voltage polarity of the ring electrodes. Furthermore, the copper circuit is coated with an isolating film.

Moreover, the ring electrodes have a staggered arrangement to enhance uniform distribution of the organic luminary particle on conductive substrates.

The method of forming a pattern on a conductive substrate comprises the following steps:

a) Placing a conductive substrate in front of electrical conductor rollers;

b) Sending pattern data to a central processor so that a feeding roller and a magnetic roller start rolling and organic luminary particle is mixed with carrier beads and thereby charged by friction, and a voltage supply device provide voltage for ring electrodes;

c) Voltage for the voltage conductor roller provided by the voltage supply device and transferred to the conductive substrate by the electrical conductor roller;

d) Changing the polarity of ring electrodes a voltage control device to project the organic luminary particle on the conductive substrate through the apertures when the conductive substrate passes over the magnetic roller;

e) Forming a pattern of uniform thickness on the conductive substrate by electrostatic force due to attachment of the organic luminary powder; and

f) Heating the conductive substrate to bond the organic luminary powder thereto.

The invention utilizes a conductive substrate to form an electrical field wider range, thereby obtaining a more uniform distribution compared with the conventional TonerJet method. Moreover, the ferromagnetic carrier beads gather to form groups on the surface of the magnetic roller, guiding the organic luminary powder for projection.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a vacuum oven as referenced in the Prior Art;

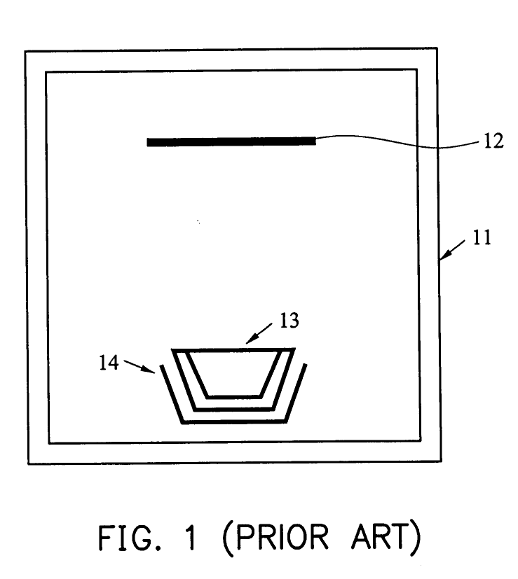

FIG. 2 is a schematic view of the pattern-formation device using TonerJet method;

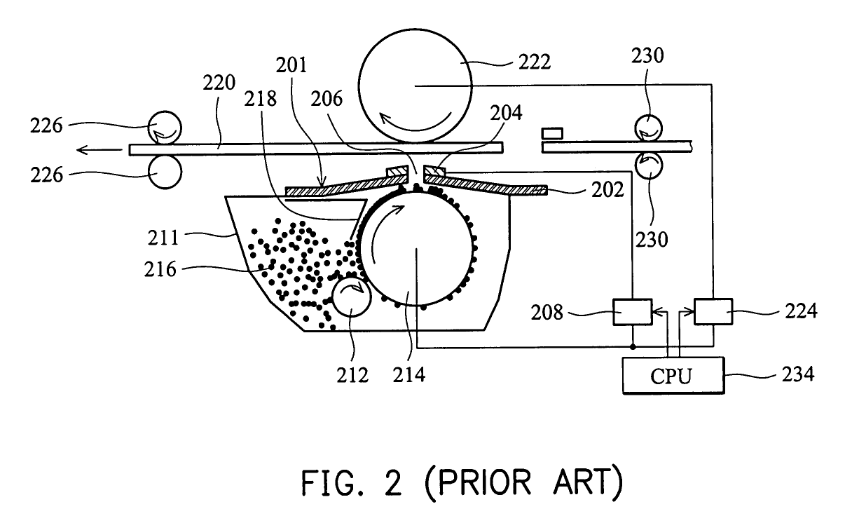

FIG. 3 is a schematic view of an embodiment of the invention;

FIG. 4 is a perspective view showing the ring electrodes on the aperture electrode device of the invention;

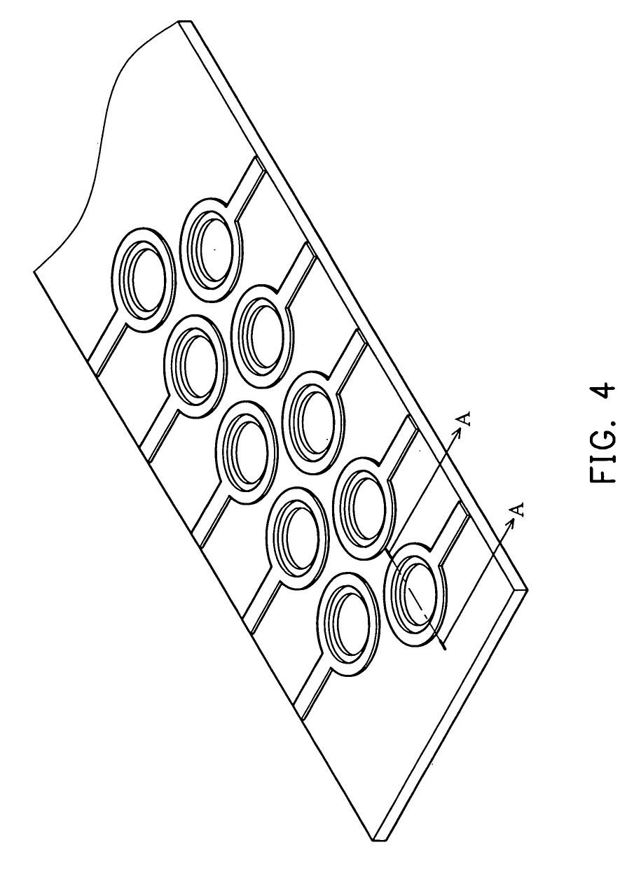

FIG. 5 is a sectional view of the ring electrodes along line A-A in FIG. 4 of the invention;

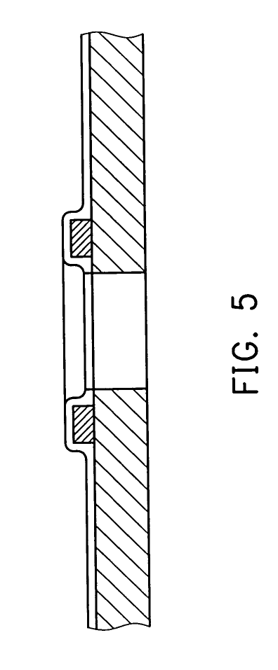

### DETAILED DESCRIPTION OF THE INVENTION

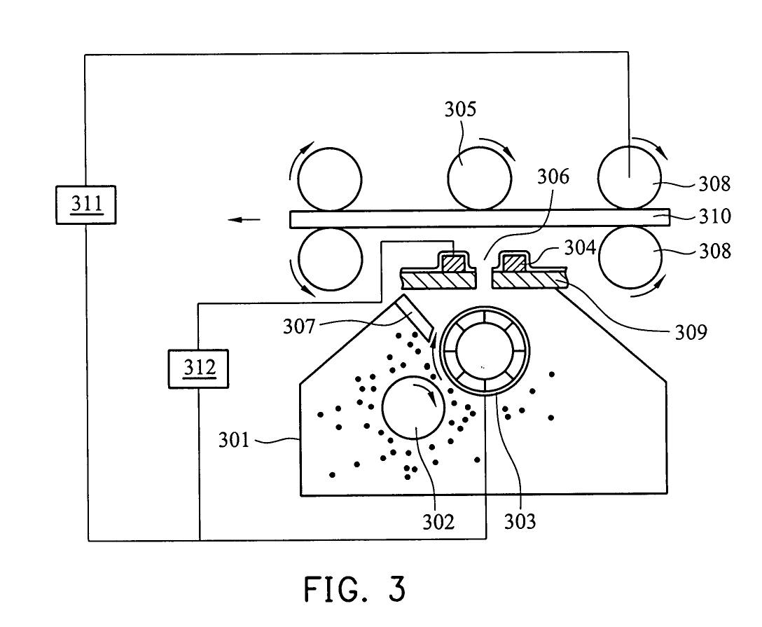

Referring to FIG. 3, a container 301 loading organic luminary powder and carrier beads is made of material that will not charge the organic luminary powder by friction. The container 301 is provided with a magnetic roller 303 and a feeding roller 302. The magnetic roller 303 has a magnetic rod fixed inside and rolls the ferromagnetic carrier beads to charge the organic luminary powder by friction. The feeding roller 302 feeds the carrier beads and organic luminary powder. Limiter 307 limits the amount of organic luminary powder reaching the ring electrodes. The ferromagnetic carrier beads are attached to the magnetic roller 303 by the magnetic force from the magnetic rod inside.

An aperture electrode device comprises a flexible circuit board 309 and a plurality of ring electrodes 304. The flexible circuit board 309 can be made of polyimide. The voltage level and polarity of the ring electrodes 304 is provided by a voltage control device 312 having a processor to determine the throughout of the organic luminary powder. An Indium Tin Oxide (ITO) layer on the conductive substrate 310 faces the ring electrodes 304. Rollers 305 and 308 start and move the conductive substrate at a constant velocity wherein the roller 308 (electrical conductor roller) connects to the voltage supply device 311 and provides negative voltage to the conductive substrate. The magnetic roller 303 is grounded, thereby forming an electrostatic field between the ITO layer and the magnetic roller 303. When the ring electrodes 304 have negative voltage, the positive charged organic luminary powder passes through the apertures 306 and then attaches to the ITO layer by the attractive electrical force to form the required pattern. When the voltage of the ring electrodes 304 becomes positive, the organic luminary powder stays in the container 301 due to the repellent force therein.

The resolution of the pattern depends on the size of apertures 306 and the arrangement of the ring electrodes 304. The smaller the apertures 306, the smaller the projection dots can be obtained. A staggered arrangement of the ring electrodes 304 is adapted to shorten the distance between the two ring electrodes and thereby enhances resolution. Moreover, the uniform distribution of the organic luminary powder is also important.

When forming patterns, the conductive substrate 310 is placed in front of the electrical conductor roller 308, sending pattern data signals to the processor of the voltage control device 312. The feeding roller 302 and the magnetic roller 303 start and charge the organic luminary powder by friction. The voltage supply device 311 provides the ring electrodes 304 with voltage of the same polarity as the organic luminary powder, and provides the electrical conductor roller 308 with voltage of the opposite polarity to the organic luminary powder. Then the conductive substrate 310 is transferred by the two electrical conductor rollers 308. When the conductive substrate 310 moves over the magnetic roller 303, the voltage polarity of the ring electrodes 304 is changed by voltage control device 312 to force the organic luminary powder through the apertures 306, thereby attaching to the conductive substrate 310 to form a uniformly distributed organic luminary layer.

The organic luminary powder attaching on the conductive substrate 310 is heated by temperature-controlled stage to bond to the conductive substrate 310. When the organic luminary powder is heated from solid state to vapor, a upper conductive substrate identical to the conductive substrate 310 is placed over the conductive substrate 310 and apart from the conductive substrate 310. The organic luminary powder is evaporated to attach to the upper conductive substrate. The pattern is on the upper conductive substrate is stripped shape and the width thereof is the same as the width formed by the organic luminary powder. The longitudinal side of the upper conductive substrates is parallel to the moving direction of the conductive substrate.

When a colored pattern is required, various pattern formation devices with different color powder are adapted and project one color powder at a time in turn on the substrate in tandem. For example, when a three-color pattern is required, three pattern formation devices with various color powder are adapted and project one color powder at a time in turn on the substrate.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for pattern formation on a conductive substrate, comprising:
an aperture electrode device comprising a plurality of ring electrodes and a plurality of apertures corresponding thereto;
a plurality of ferromagnetic carrier beads;
a feeding device feeding organic luminary powder, including a feeding roller and a magnetic roller which mix the organic luminary powder with the ferromagnetic carrier beads and charge the organic luminary powder by friction;
a movable conductive substrate comprising a plate and a layer of conductive material coated on the plate;
a voltage supply device providing voltage for the movable conductive substrate and the magnetic roller;
at least one electrical conductor roller connected to the voltage supply device and contacting the movable conductive substrate to provide voltage for the movable conductive substrate; and
a voltage control device controlling the voltage in the plurality of ring electrodes, thereby forming a electrical field to attract or repel the organic luminary powder.

2. The apparatus for pattern formation on a conductive substrate as claimed in claim 1, wherein the aperture electrode device further comprises a flexible circuit board on which the ring electrodes and the apertures are provided.

3. The apparatus for pattern formation on a conductive substrate as claimed in claim 2, wherein the flexible circuit board is a polyimide board.

4. The apparatus for pattern formation on a conductive substrate as claimed in claim 1, further comprising a limiter mounted on magnetic roller to limit the amount of the organic luminary powder reaching the s plurality of ring electrodes.

5. The apparatus for pattern formation on a conductive substrate as claimed in claim 1, further comprising a copper foil circuit with which the voltage control device connects to the plurality of ring electrodes.

6. The apparatus for pattern formation on a conductive substrate as claimed in claim 5, further comprising an isolating film coated on the copper foil circuit.

7. The apparatus for pattern formation on a conductive substrate as claimed in claim 1, wherein the ring electrodes have a staggered arrangement to enhance uniform distribution of the organic luminary powder.

8. The apparatus for pattern formation on a conductive substrate as claimed in claim 1, wherein the organic luminary powder is non-magnetic.

9. The apparatus for pattern formation on a conductive substrate as claimed in claim 1, wherein the ring electrodes control the amount of organic luminary powder projected onto the movable conductive substrate through the apertures.

10. The apparatus for pattern formation on a conductive substrate as claimed in claim 1, wherein the electrical polarity of the conductive substrate is opposite to that of the organic luminary powder.

11. The apparatus for pattern formation on a conductive substrate as claimed in claim 1, wherein the voltage of the ring electrodes controls the amount of organic luminary powder passing through the apertures.

12. The apparatus for pattern formation on a conductive substrate as claimed in claim 1, wherein a electric field is formed between the magnetic roller and the conductive substrate for attracting the charged organic luminary powder, the electrical polarity of the conductive is contrary to the electrical polarity of the organic luminary powder.

13. A method for pattern formation on a conductive substrate, comprising the steps of:
placing a conductive substrate in front of electrical conductor rollers;
sending pattern data to a central processor so that a feeding roller and a magnetic roller mix the organic luminary powder with carrier beads therebetween, thus charging the organic luminary powder by friction;
providing voltage for the voltage conductor roller and ring electrodes by a voltage supply device and transfer to the conductive substrate by the electrical conductor rollers;
changing the polarity of ring electrodes by a voltage control device to project the organic luminary powder on the conductive substrate when the conductive substrate passes over the magnetic roller;
forming a pattern of uniform distributed organic luminary powder on the conductive substrate; and
heating the conductive substrate and thereby bonding the organic luminary powder thereon.

14. The method for pattern formation on a conductive substrate as claimed in claim 13, wherein static electricity is distributed on the conductive substrate when voltage is applied to the ring electrodes.

15. The method for pattern formation on a conductive substrate as claimed in claim 13, wherein the conductive substrate is made of transparent glass or metal plate depending on the bonding conditions of the organic luminary powder.

16. The method for pattern formation on a conductive substrate as claimed in claim 13, wherein the long side of the conductive material layer is parallel to the moving direction of the movable conductive substrate.
